(19) United States
(12) Patent Application Publication
(10) Pub. No.: US 2002/0043831 A1
(43) Pub. Date: Apr. 18, 2002

(54) Driver head restraint

(76) Inventor: Andrew Jackson Alsup, Mooresville, NC (US)

Correspondence Address: Ralph H. Dougherty, Two Fairview Center, Suite 400, 6230 Fairview Road, Charlotte, NC, 28210, US

(21) Appl. No.: 09/908,248

(22) Filed: Jul. 18, 2001

Related U.S. Application Data
(60) Provisional application No. 60/218,892, filed on Jul. 18, 2000.

(51) Int. Cl. B60N 2/42

(52) U.S. Cl. 297/216.12

(57) ABSTRACT

An improved head restraint apparatus is fastened to the seat back of a race car seat and extends forward in a loop fashion which fits loosely around the upper portion of a race car helmet, above the goggle or site area. The head restraint may include a dampener for aiding in absorbing the effect of an impact, such as a pneumatic or hydraulic piston.

### CROSS REFERENCE TO RELATED APPLICATION

This application claims the benefit of U.S. Provisional Patent Application No. 60/218,892, filed Jul. 18, 2000.

### FIELD OF THE INVENTION

The present invention relates to safety devices for automobile racing and other motor sport racing. More particularly, the invention relates to a method and apparatus for restraining helmet movement and preventing catastrophic movement of a driver's head in a rapid deceleration or in a crash.

### BACKGROUND OF THE INVENTION

Racing of powered vehicles, whether the vehicle be a car, truck, motorcycle, aircraft or watercraft, is a dangerous sport. Drivers or pilots can easily be injured or killed when racing, particularly when operating at the high speeds achieved during a race.

Race car drivers are held into their seats by a five point racing harness. In the event of a crash the harness generally has about a three inch give or resilience, however, race car drivers wear a state of the art helmet which is not restrained in any way. When a driver hits an object such as a wall at speeds in excess of 100 mph, the driver's body is restrained, but, particularly if the object is immovable, the driver's head moves forward with the body, then the head snaps forward and downward, frequently resulting in a broken neck and death.

Certain military aircraft pilots and test pilots wear a helmet; some of which helmets are provided with an anchor strap which is buckled to the seat back. Such anchor strap restricts or prevents head rotation and limits peripheral vision.

### SUMMARY OF THE INVENTION

The invention is a head restraint which is fastened to the seat back of a race car seat and extends forward in a loop fashion which fits loosely around the upper portion of a race car helmet, above the goggle or site area. The restraint has about the same give as the harness allowing about a three inch forward movement upon the occurrence of frontal impact.

The basic concept of the invention is a head or helmet restraint which is attached to the rear of the seat back, i.e., the portion of the seat back which extends up into the region behind the head or helmet. The restraint loosely encircles the driver's helmet. A high tensile strength nylon strap, preferably a web strap, fixed to the seat back comprises the basic invention. The strap must have sufficient stiffness to prevent sagging of the restraint into the driver's field of vision.

It should be noted that side restraints are currently provided on race car seats which prevent a driver's head from snapping sideways upon a side impact.

The present invention includes a strap which may be inserted into a plastic tube, such as polypropylene tubing to provide some stiffness and to hold the restraint horizontally at a generally level height where it does not interfere with the driver's sight. In other words, the restraint will not sag when in use.

To further strengthen and hold the restraint substantially level, a piece of LEXAN or other plastic can be placed either over or under the webbing and extend into each end of the tube a sufficient distance to provide support.

The present invention is particularly useful for race car drivers, automotive test drivers, stunt pilots, test pilots, and high speed drivers of any vehicle which has a high sear back (i.e., extending to about the top of the driver's head) to which the head restraint may be affixed.

### OBJECTS OF THE INVENTION

The principal object of the present invention is to provide a device for restraining forward movement of a race driver's head upon rapid deceleration.

Another object of the invention is to provide a forward head restraint which enables a driver to turn his head and the helmet thereon within the restraint.

A further object of this invention is to provide a head restraint for a race car driver which allows limited movement of the driver's head.

Another object of this invention is to provide a method of reducing the likelihood of a broken neck in a high speed disaster.

### BRIEF DESCRIPTION OF THE DRAWINGS

The foregoing and other objects will become more readily apparent by referring to the following detailed description and the appended drawings, in which:

FIG. 1 is an isometric view of a race car seat with the invented head restraint installed thereon.

FIG. 2 is a side view of a portion of a race car seat back with the invented head restraint installed thereon and showing its relationship to a driver's helmet.

FIG. 3 is a rear view of a portion of a race car seat showing the invented head restraint installed thereon.

FIG. 4 is a top view of the head portion of a race car seat with the invented head restraint installed thereon.

FIG. 5 is an alternative embodiment showing a tubular head restraint with a web portion inserted into a tubular member prior to its installation on a seat back.

FIG. 6 is a side elevation of a driver in a race car seat and showing another alternative head restraint.

FIG. 7 is a top view of a driver's helmet and the head restraint of FIG. 6.

FIG. 8 is a partially cutaway side detail view of a portion of FIG. 7.

FIG. 9 is a top view of another alternative embodiment of the invented head restraint.

FIG. 10 is an isometric view of the head restraint shown in FIG. 9.

### DETAILED DESCRIPTION

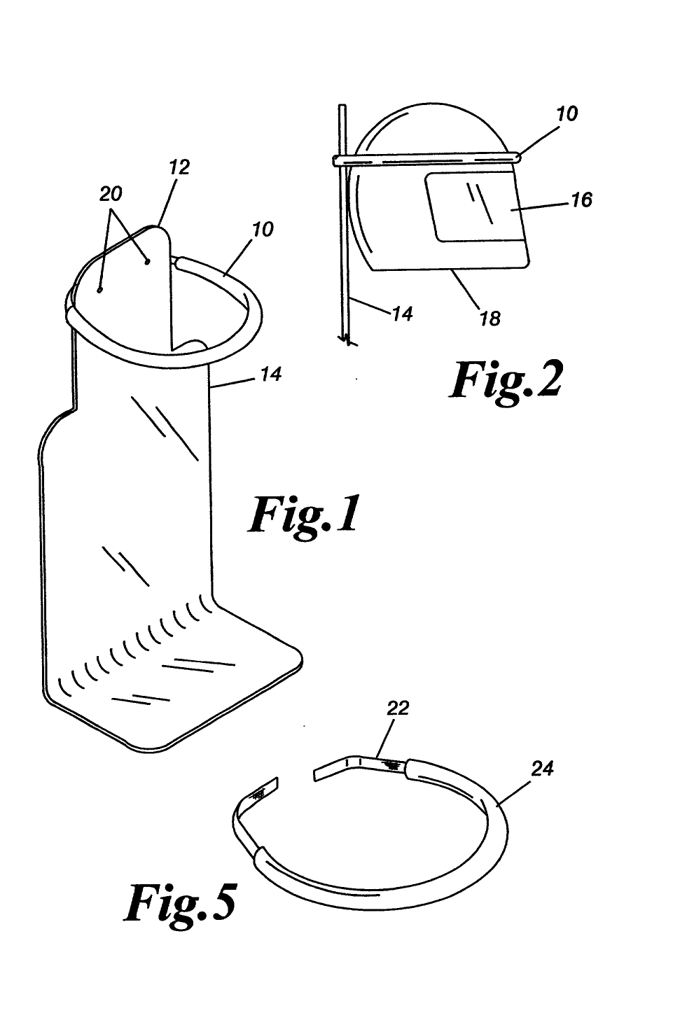

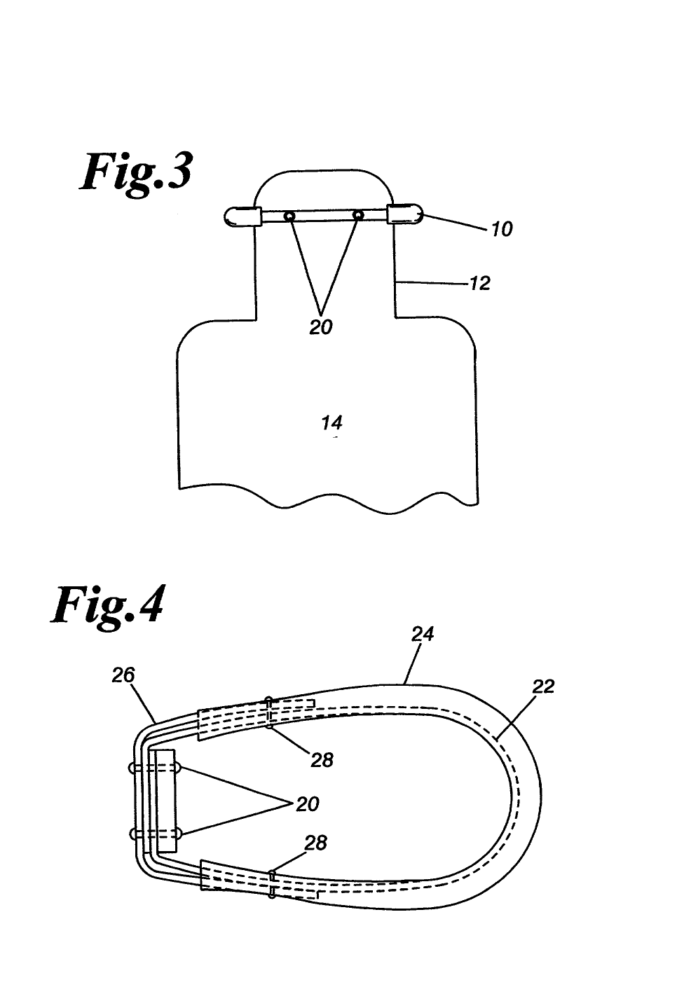

Referring now to the drawings, and particularly to FIG. 1, the invented head restraint 10 is installed on the head portion 12 of a seat back 14. As is shown in FIG. 2, the restraint 10 is positioned horizontally so that it stays above the driver's eye shield 16 of helmet 18. FIG. 3 shows the invented restraint riveted or otherwise fixed to the head portion 12 of the seat back by rivets 20, bolts, or the like.

FIG. 4, which is a top view, shows the details of the head restraint in which a web strap 22 passes through a tube such as a polypropylene tube 24, and a LEXAN strap 26 is inserted partway into the tube to provide vertical stability and prevent sagging into the user's field of view. The ends of strap 22 are fully overlapping and are double riveted at 20. The LEXAN strap 26 is attached to the tube 24 and the web strap 22 at or near its end within the tube 24 by rivets 28 or other fasteners.

FIG. 5 shows an alternative embodiment in which only a web strap 22 is inserted into a plastic tube 24 to form a head restraint. The free ends of web 22 are then fixed to the head portion 12 of the seat back 14 in the same manner as shown in FIG. 4.

It can readily be seen that the present invention is usable by any operator of any vehicle, aircraft or racing device which includes a seat support having a head portion. This clearly includes racing vehicles and airplanes, such as trucks, automotive vehicles, certain motorcycles, speedboats and midget race cars.

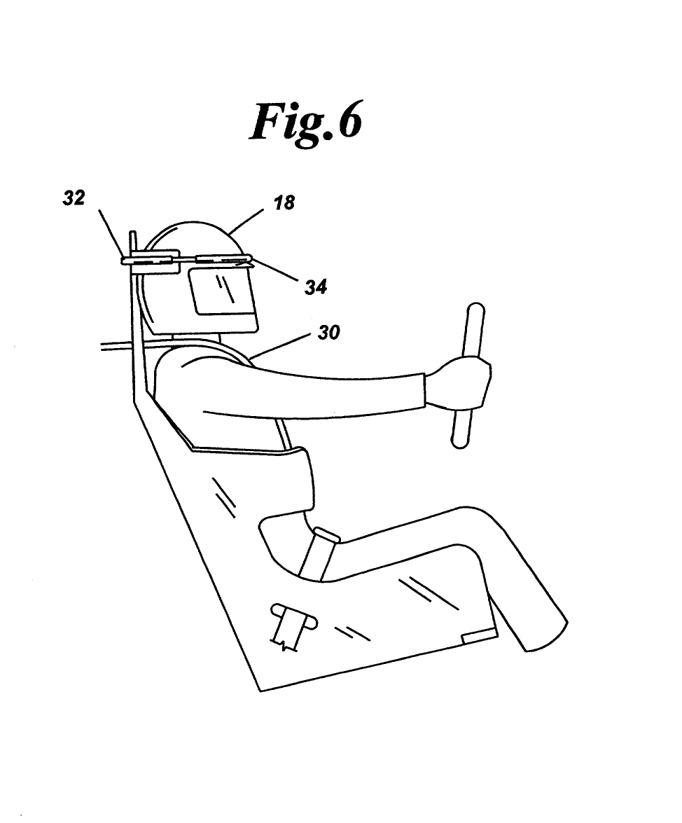

In operation, a driver or pilot positions himself on a seat 14, fastens all safety belts and body restraints, e.g., the five point racing harness 30 (shown in FIG. 6), and positions the head restraint 10 loosely around the helmet above the eye shield 16. In the event of a rapid deceleration, the head restraint has about the same give or resilience as the harness, thus preventing the driver's head from snapping forward, and avoiding a broken neck.

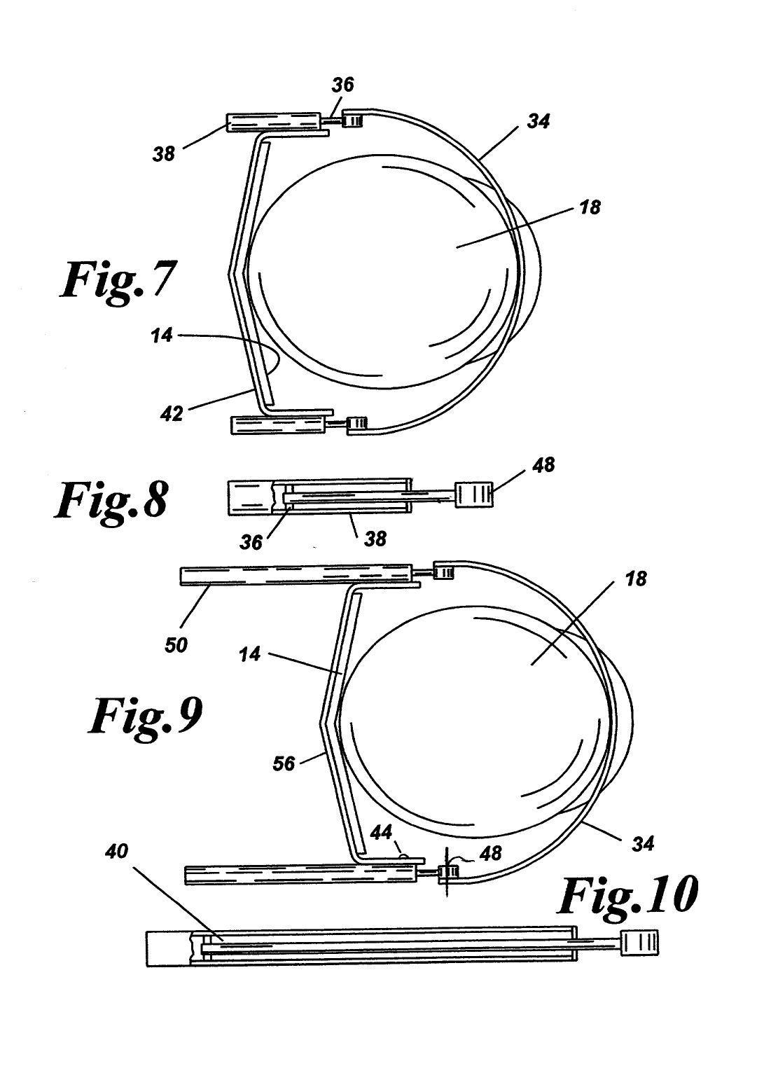

The restraint shown in FIGS. 6 and 7 has a dampener 32 incorporated therein which resists forward movement of the head while it allows some forward movement of the head and helmet. The dampener 32, which is actually a pair of generally parallel pistons attached to each end of the helmet encircling member or halo 34, comprises a dampener piston 36 encased in a housing 38. The housing 38 may have air or a fluid 40 such as oil encased therein to provide resistance for the piston 36 (i.e., resistance to movement of the piston may be hydraulic or pneumatic). Strap 42, which may be a single strap or multiple straps, is affixed to the seat back 14 and to the piston housing 38. This strap 42 may be affixed to the housing 38 by any desired means, such as a stud or rivet which may be a portion of the housing 38, or the stud may be welded or otherwise fastened to the housing 38. The halo 34 should be oriented in such manner that it does not sag into the driver's line of sight. This can be accomplished with a very tight connection 48 or a connector can be elongated or have a predetermined shape such as triangular, or it can be a multiple fastener connection, all of which will resist rotation of the halo 34 about the connection 48.

Alternatively, the connection 48 may be a pivotal connector, to aid in positioning the head restraint into the operating position, and to allow ready access to the driver at any time, regardless of whether or not a crash has occurred. The pivotal connection may include a limiting stop to prevent sagging.

In the alternative embodiment shown in FIGS. 9 and 10, the dampener 50 can be connected to the seat back 14, either directly or through an intermediate support 56. This allows the dampener 50 to have a greater portion of its length extending rearwardly behind the seat, which enables the dampener to have a greater impact absorbing capability than the shorter piston dampener 32 shown in FIG. 6.

### SUMMARY OF THE ACHIEVEMENT OF THE OBJECTS OF THE INVENTION

From the foregoing, it is readily apparent that I have invented an improved head restraint for race car drivers and pilots, which restrains forward movement of a race driver's head upon rapid deceleration, which enables a driver to turn his head and the helmet thereon within the restraint, and which allows limited movement of the driver's head.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A head restraint for a vehicle in which the driver wears a helmet and is situated in a seat having a seat back with a head portion extending upwardly generally about the height of the driver's head, said restraint comprising:
helmet encircling means fixed to the head portion of the seat back and extending forwardly to loosely encircle the driver's helmet.

2. A head restraint according to claim 1 further comprising means fixed to said helmet encircling means for maintaining the restraint in a substantially horizontal position where it will not sag and interfere with the driver's sight.

3. A head restraint according to claim 1 wherein said encircling means is a high tensile strength web strap.

4. A head restraint according to claim 1 wherein said restraint includes a tubular member covering at least a portion of the helmet encircling means.

5. A head restraint according to claim 3 wherein said web strap is nylon.

6. A head restraint according to claim 1 wherein said helmet encircling means is fixed to the rear of the head portion of the seat back.

7. A head restraint according to claim 1 further comprising dampening means for dampening rapid forward movement of the restraint in the event of a crash.

8. A head restraint according to claim 1 wherein said dampening means comprises a housing, a fluid encased in said housing, a piston encased in and movable in said housing, said housing being affixed to said seat back, and said helmet encircling means being attached to said piston.

9. A method of reducing neck injuries to a helmet-wearing person in the event of a high speed crash, comprising the steps of:
providing a seat having helmet encircling means fixed to the seat;
providing means for limiting the forward movement of said helmet encircling means; and
positioning the helmet encircling means loosely around the helmet above the eye shield.
